(19) United States
(12) Patent Application Publication
(10) Pub. No.: US 2013/0280443 A1
(43) Pub. Date: Oct. 24, 2013

(54) FLOW APPLICATOR APPARATUS AND METHODS OF APPLYING A LAYER OF CEMENT MATERIAL TO A HONEYCOMB BODY

(71) Applicants: Edward Francis Andrewlavage, JR., Corning, NY (US); John Crawford Anthony, Corning, NY (US)

(72) Inventors: Edward Francis Andrewlavage, JR., Corning, NY (US); John Crawford Anthony, Corning, NY (US)

(21) Appl. No.: 13/451,077

(22) Filed: Apr. 19, 2012

(51) Int. Cl. B06B 1/00; B05C 11/02

(52) U.S. Cl. 427/600; 118/612

(57) ABSTRACT

Apparatus and methods are provided for applying a layer of cement material to a honeycomb body. Each apparatus can include an oscillatory member and an applicator body with a dispensing port and an interior area. The methods can each include the steps of charging the interior area with the cement material and oscillating the oscillatory member to modify a material property of the cement material. The methods can each further include the steps of dispensing the cement material from the interior area through the dispensing port and applying the cement material to the outer circumferential surface of the honeycomb body.

### FIELD

The present invention relates generally to flow applicator apparatus and methods of applying a layer of material and, more particularly, to flow applicator apparatus and methods of applying a layer of cement material to a honeycomb body.

### BACKGROUND

It is known to produce honeycomb bodies of ceramic material. It is also known to further process the honeycomb bodies by applying a cement mixture to an outer circumferential surface of a honeycomb body.

### SUMMARY

In one aspect, a flow applicator apparatus is disclosed herein including an applicator body. The applicator body includes an interior area configured to receive a cement material. The applicator body further includes a dispensing port configured to dispense cement material from the interior area. The flow applicator apparatus also includes an oscillatory member configured to modify a material property of the cement material being dispensed through the dispensing port.

In another aspect, a method is provided for applying a layer of cement material to a honeycomb body comprising a longitudinal axis extending through opposing end faces. The honeycomb body further comprises an outer circumferential surface extending about the longitudinal axis and between the end faces. The method includes the step of providing an applicator body including an interior area, a dispensing port and an oscillatory member. The method further includes the step of charging the interior area with cement material. The method also includes the step of oscillating the oscillatory member to modify a material property of the cement material. The method still further includes the step of dispensing the cement material from the interior area through the dispensing port. The method also includes the step of applying the cement material to the outer circumferential surface of the honeycomb body.

In yet another aspect, a method is provided for applying a layer of cement material to a honeycomb body comprising a longitudinal axis extending through opposing end faces. The honeycomb body further comprises an outer circumferential surface extending about the longitudinal axis and between the end faces. The method includes the step of providing an applicator body. The applicator body includes an interior area and a dispensing slot. The dispensing slot includes a static width defined by a distance between a first lip and a second lip. The first lip is defined by an oscillatory member and the second lip is defined by a fixed portion of the applicator body. The method further includes the step of charging the interior area with cement material. The method still further includes the step of oscillating the oscillatory member to provide a dynamically changing width between the first lip and the second lip. The method also includes the step of dispensing the cement material from the interior area through the dispensing port. A viscosity of the cement material is reduced by the dynamically changing width between the first lip and the second lip as the cement material is passed through the dispensing slot. The method further includes the step of applying the dispensed cement material to the outer circumferential surface of the honeycomb body.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic view of a skinning apparatus with a honeycomb body with end faces positioned between corresponding support members of the skinning apparatus;

FIG. 2 is a sectional view of the skinning apparatus and honeycomb body along line 2-2 of FIG. 1 illustrating the interior construction and circumferential surface of the honeycomb body and further schematically illustrating a flow applicator apparatus in accordance with aspects of the disclosure;

FIG. 3 is a schematic view of the skinning apparatus with the honeycomb body of FIG. 1 and further showing the flow applicator apparatus of FIG. 2 positioned proximate to the honeycomb body;

FIG. 4 is a sectional perspective view of the flow applicator apparatus of FIG. 3;

FIG. 5 is a sectional plan view of the flow applicator apparatus along line 5-5 of FIG. 3;

FIG. 6 is a sectional perspective view of the flow applicator apparatus of FIG. 3 with associated control devices for the oscillatory member;

FIG. 7 is a graph showing the visco-elastic behavior of an example cement material;

FIG. 8 is a graph showing the relationship between the flow rate of an example cement material and the amplitude and frequency of the oscillatory member;

FIG. 9 is a schematic view of the skinning apparatus with the honeycomb body of FIG. 3 with the honeycomb body rotates while the flow applicator apparatus continues to apply a layer of cement material to the honeycomb body; and

FIG. 10 is a sectional view of the apparatus and honeycomb body along line 10-10 of FIG. 9 illustrating a layer of cement material being applied on the circumferential surface of the honeycomb body.

### DETAILED DESCRIPTION

The present invention will now be described more fully hereinafter with reference to the accompanying drawings in which example embodiments of the claimed invention are shown. Whenever possible, the same reference numerals are used throughout the drawings to refer to the same or like parts. However, the claimed invention may be embodied in many different forms and should not be construed as limited to the embodiments set forth herein. These example embodiments are provided so that this disclosure will be both thorough and complete, and will fully convey the scope of the claimed invention to those skilled in the art.

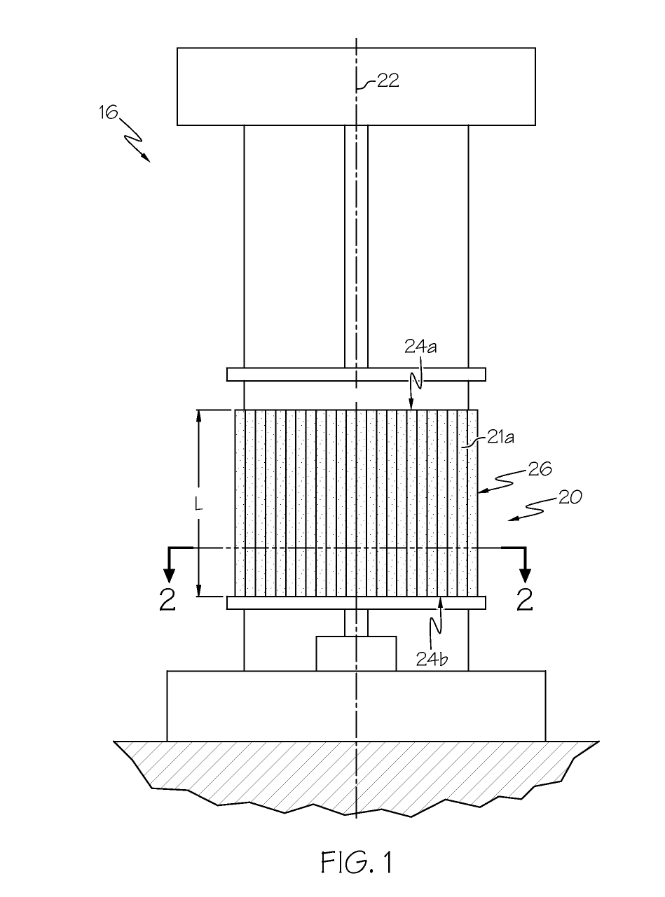

Referring now to FIG. 1, a skinning apparatus 16 is provided that is configured to apply a cement material to a honeycomb body. Honeycomb bodies can be used in various filtering applications. For instance, honeycomb bodies can be used as a flow through substrate or as a particulate filter for processing exhaust from a combustion engine. In some examples, the honeycomb bodies may be loaded with a catalyst to reduce nitrogen oxide compounds or other environmental pollutants. Various materials may be used to form the honeycomb bodies. For instance, honeycomb bodies may be comprised of ceramic material such as cordierite, mullite, silicon carbide, aluminum titanate or other materials or combinations thereof. During production of the ceramic honeycomb body, raw materials such as inorganic materials, a liquid vehicle, and a binder are mixed into a batch. The batch is then extruded into a green honeycomb body. The green body can then be heated to be dried and further heated and processed into a fired honeycomb body of refractory material, such as ceramic.

The honeycomb body can comprise various structural configurations depending on the particular application. For example, as shown in FIG. 1, the honeycomb body 20 can include a longitudinal axis 22, such as the illustrated symmetrical axis, extending through opposing end faces 24a, 24b. As shown, each of the end faces 24a, 24b can be substantially planar but may have different configurations in further examples. As further illustrated, the end faces 24a, 24b can be substantially parallel to one another although the end faces may extend at an angle to one another in further examples. Still further, one or both of the end faces 24a, 24b can be substantially perpendicular to the longitudinal axis 22 as shown in FIG. 1.

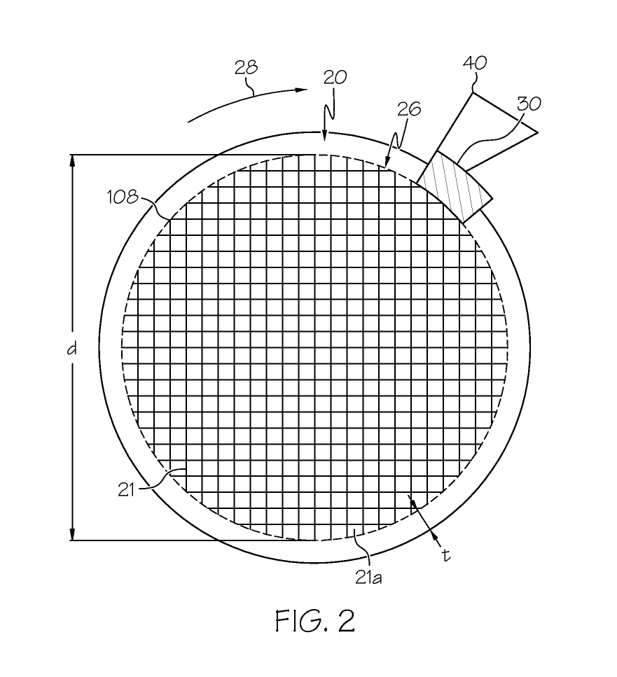

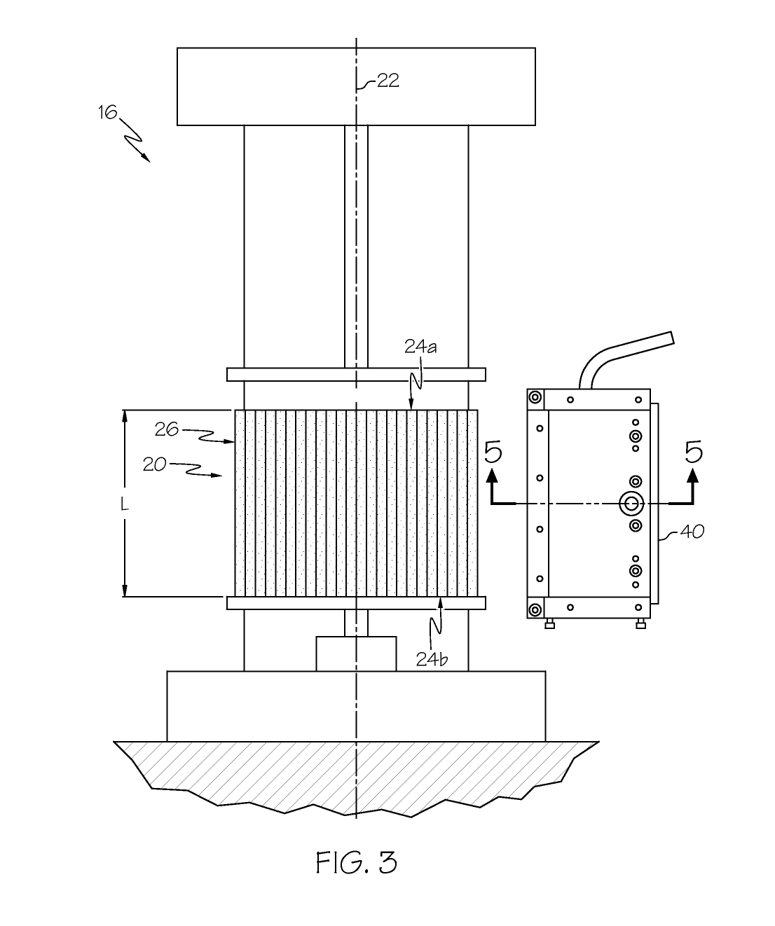

The honeycomb body can further include various shapes and sizes. For instance, as shown in FIGS. 1 and 3, the honeycomb body 20 can have a length “L” approximately equal to an outer dimension “d” (best seen in FIG. 2) although the length “L” may be substantially greater or less than the outer dimension “d” in further examples. The honeycomb bodies can also include a circumferential surface extending about the longitudinal axis between the end faces 24a, 24b. In examples, the circumferential surface can have a cross sectional shape substantially equal or geometrically similar to the peripheral shape of at least one of the end faces 24a, 24b.

The illustrated honeycomb body 20 includes a surface 26 extending about the longitudinal axis 22 between the end faces 24a, 24b. As shown in FIG. 2, the circumferential surface 26 has a cross section with a substantially circular periphery wherein the outer dimension “d” comprises the diameter of the circle. As shown, the actual circumferential surface 26 can comprise exposed portions of partial channels 21a although a substantially continuous circumferential surface may be provided in further examples which can depend on the extrusion die configuration. Although not shown, the circumferential surface 26 can alternately comprise an oval shape or other curvilinear shape. In further examples, the circumferential surface 26 may have a triangular, rectangular or other polygonal shape.

As further illustrated in FIG. 2, the honeycomb body includes channels 21 extending along a direction of the longitudinal axis 22. In further examples, the channels may extend along other directions to provide communication between the end faces 24a, 24b. As shown, the channels 21 can be provided as a matrix of channels defined by adjacent sidewalls. The illustrated sidewalls provide each interior channel with a substantially square shape. In further examples, the channels can comprise circular, oval or other curvilinear shape. In still further examples, the channels can comprise other polygonal shapes with three or more sides.

FIG. 2 also shows a flow applicator apparatus 40 for applying a layer of cement material 30 to the circumferential surface 26. In one example, the honeycomb body 20 can be rotated in the direction of arrow 28 during the application so that a stationary flow applicator apparatus 40 can apply cement material 30 to at least a portion, such as all, of the circumferential surface 26 of the honeycomb body 20. The cement material 30 can comprise various materials and may be formed from substantially the same material as the honeycomb body 20 or the materials from which the honeycomb body 20 is formed, such as a mixture of inorganic materials, a binder and/or a liquid vehicle.

As shown in FIG. 3, examples of the flow applicator apparatus 40 can extend along substantially the entire length “L” of the honeycomb body 20. In further examples, the flow applicator apparatus 40 may have a length less than the length of the honeycomb body. In one example, the flow applicator apparatus 40 may be disposed in proximity to the circumferential surface such that the cement material 30 can be applied directly to the circumferential surface. Moreover, the flow applicator apparatus 40 can be located toward the top of the cylindrical surface to allow gravity to help spread the cement material 30 during the application procedure. While FIG. 3 shows the flow applicator apparatus positioned in a position generally vertical and normal to the cylindrical honeycomb body 20, other orientations are also contemplated.

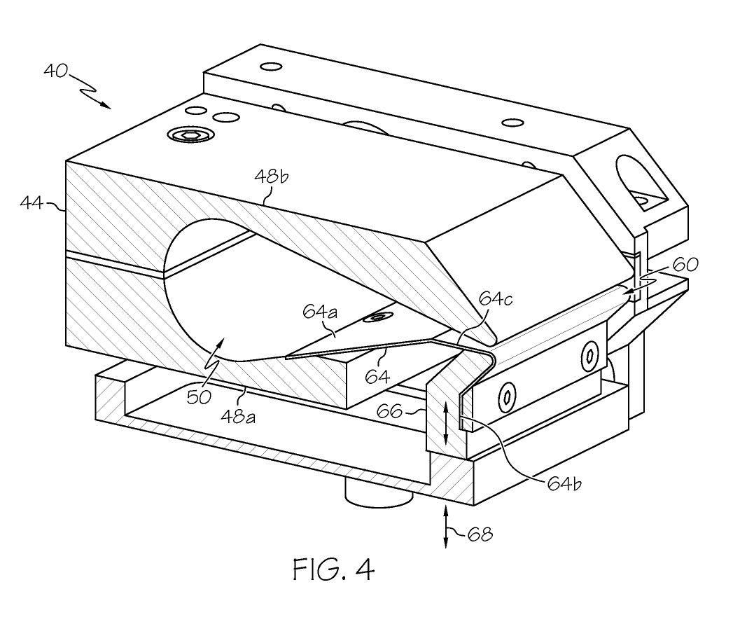

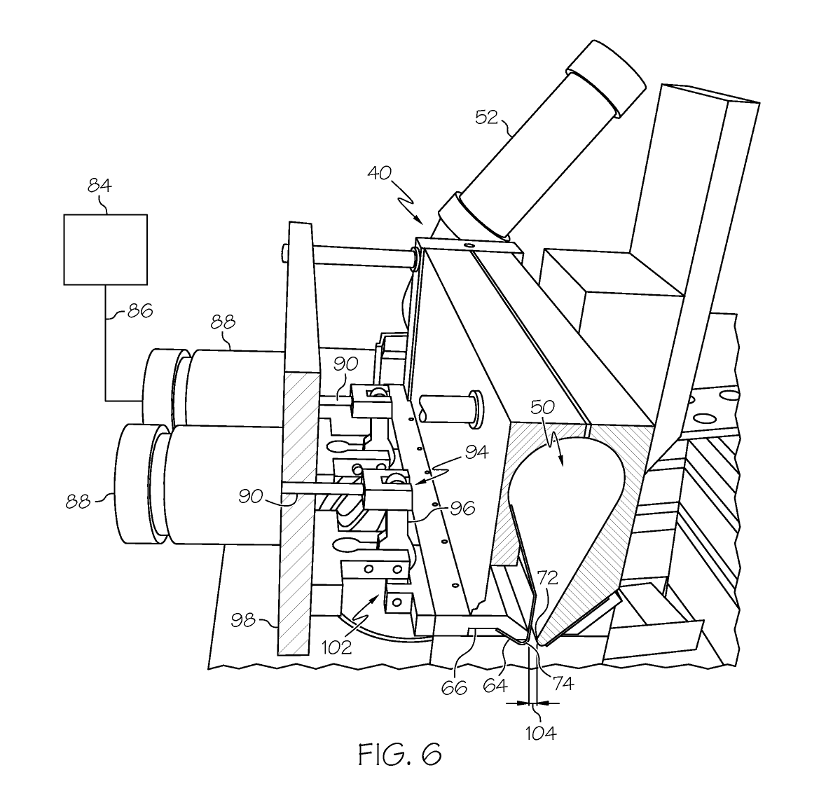

As shown in FIG. 4, the flow applicator apparatus 40 comprises an applicator body 44 that defines an interior area 50. Optionally, the applicator body 44 can include multiple portions that are fixed relative to one another. For example, as shown, the applicator body 44 can optionally include a first fixed portion 48a and a second fixed portion 48b that can be fixedly attached to one another to define the interior area 50. As shown, the interior area 50 can comprise a tear-drop cross-sectional shape, however, further examples can include any number of cross-sectional shapes. The interior area 50 of the applicator body 44 is configured to receive the cement material 30. In one example, the cement material 30 can be delivered to the interior area 50 through a supply conduit 52 (best seen in FIG. 6).

The flow applicator apparatus 40 further comprises a dispensing port 60 configured to dispense cement material 30 from the interior area 50. FIG. 4 shows a portion of the dispensing port 60 as an elongated slot through which the cement material 30 can pass just prior to being applied to the circumferential surface 26 of the honeycomb body 20. Suitable overall dimensions of the dispensing port 60 can be predetermined while considering the pressure and the viscosity of the cement material 30 as it flows out of the dispensing port 60 onto the circumferential surface 26 of the honeycomb body 20. The overall dimensions of the dispensing port 60 can also vary to accommodate different surface configurations of the honeycomb body. Additionally, the illustrated dispensing port 60 optionally comprises an elongated rectangular slot. In further examples, the dispensing port can comprise other shapes such as square, oval, circle, triangle, or other shape configurations.

The flow applicator apparatus 40 further comprises an oscillatory member 64 configured to modify a material property of the cement material 30 being dispensed through the dispensing port 60. In one example, the oscillatory member can be located at least partially, such as entirely, within the interior area 50. In further examples, the oscillatory member 64 can be located at least partially, such as entirely, within the dispensing port 60 or outside of the dispensing port 60. In one particular example, the oscillatory member 64 may be located entirely outside the dispensing port 60 so that the cement material 30 contacts the oscillatory member 64 after dispensation through the dispensing port 60 and prior to contacting the honeycomb body 20.

As shown in the illustrated example, for instance, a portion of the oscillatory member 64 can be located within the interior area 50 in order to physically contact the cement material 30 just prior to the cement material 30 entering the dispensing port 60 during an application procedure. As optionally shown in FIG. 4, an inner end 64a of the oscillatory member 64 can be attached to the first fixed portion 48a within the interior area 50 while an outer end 64b can be attached to a moving member 66 outside the interior area 50 and outside the dispensing port 60. At the same time, an intermediate portion 64c of the oscillatory member 64 can at least partially define the dispensing port 60. The moving member 66 can be configured to oscillate, for example, by reciprocating along the direction of arrow 68 when acted upon by an oscillating force. As moving member 66 reciprocates in the direction of arrow 68, at least a portion of the oscillatory member 64 (e.g., the outer end 64b) oscillates in the same direction. In further examples, the oscillatory member 64 (e.g., the outer end 64b) can be configured to oscillate in any number of directions including multiple directions. For example, the outer end 64b of the oscillatory member 64 can be configured to oscillate by reciprocating along a linear path (e.g., see arrow 68). In further examples, the outer end 64b of the oscillatory member 64 can be configured to oscillate in a closed path, such as a circular, elliptical or other curvilinear path.

Oscillatory member 64 can be composed of any suitable material, including an elastically deformable material, such as stainless steel. Oscillations transmitted to the oscillatory member 64 from moving member 66 can apply forces to the oscillatory member 64 not exceeding the elastic deformation range of the material. Thus, example oscillatory members can be undergo a large number of operating cycles without failure.

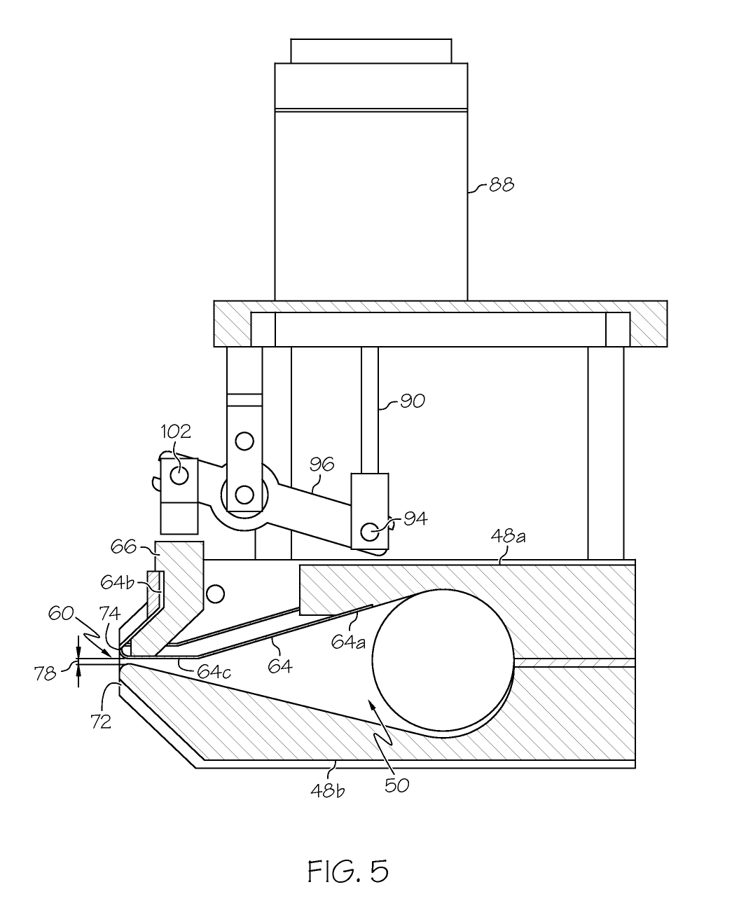

Turning to FIG. 5, the oscillatory member 64 can at least partially define the dispensing port 60. For example, the intermediate portion 64c of the oscillatory member 64 can be configured to be spaced a distance from the second fixed portion 48b to define the dispensing port 60. In this configuration, portions of the oscillatory member 64 are located within the interior area 50 and within the dispensing port 60. Thus, oscillations of the oscillatory member 64 can act on the cement material 30 that is located within the interior area 50, cement material 30 that is being dispensed through the dispensing port 60, or a combination of the two. In further examples a pair or a plurality of oscillatory members 64 can substantially entirely define the opposed elongated lips of the dispensing port 60. However, providing the oscillatory member 64 on one side of the dispensing port 60 can allow the oscillatory member 64 to act as a dynamic lip against a static lip to enhance modification of a material property of the cement material being dispensed through the dispensing port 60.

Referring to FIG. 5, for example, the second fixed portion 48b can define a static lip 72 that at least partially defines the dispensing port 60. Similarly, the intermediate portion 64c of the oscillatory member 64 can define a dynamic lip 74 so that the dispensing port comprises a slot defined by the pair of spaced apart lips 72, 74. When the oscillatory member 64 is stationary, the dispensing port 60 includes a static width 78 defined by a distance between the static lip 72 and the dynamic lip 74 that is at rest and not moving. However, when oscillating, the dynamic lip 74 can move relative to the static lip 72 to define a dynamically changing width 104 (best seen in FIG. 6) that changes as the dynamic lip 74 oscillates.

FIG. 6 shows the flow applicator apparatus 40 and an associated control unit 84. In one example, the control unit 84 can include a signal source, a servo amplifier, a DC power supply, and a line filter. The control unit 84 can transmit commands along a transmission line 86 to control an actuator 88. For example, the actuator 88 may be a voice coil wherein the control unit 84 can send an electrical signal along the transmission line 86 to control operation of the voice coil. The voice coil can be designed to cause linear reciprocation of a rod 90 as output which is proportional to the electrical signal received by the voice coil. In turn, rod 90 is pinned to a first end 94 of a rocker arm 96. The rocker arm 96 and the voice coil are attached to a plate 98 which is set-off a distance from the flow applicator apparatus 40.

A second end 102 of the rocker arm 96 is pinned to the moving member 66 such that the linear reciprocation output of rod 90 creates a corresponding oscillatory movement of the oscillatory member 64. It is to be appreciated that the lengths and geometry of the rocker arm 96 can be selected so that a particular linear reciprocation output of rod 90 creates a suitable travel distance of the oscillatory member 64. While FIG. 6 shows one particular arrangement of the control devices as described, further examples can include other arrangements.

The electrical signal that the control unit 84 transmits to the actuator 88 over along transmission line 86 can have a plurality of components. In one example, the electrical signal can have a direct current (DC) signal component and an alternating current (AC) signal component. The actuator 88 can respond to each of these components in different with a different output. For example, a DC signal component received by the actuator 88 will produce a static output of the rod 90 linearly translating to a position and holding that position. Thus, the static width of the slot can be adjustable by applying a DC signal component to the actuator 88. Application of only a DC signal component places the slot into a static state. With application of the DC signal component, the slot includes a static width 78 defined by the distance (best seen in FIG. 5) between the static lip 72 and the dynamic lip 74 when the slot is in the static state. The DC signal component can be referred to as the DC offset voltage. A suitable static width of the dispensing port 60 can be selected dependent upon certain operating variables. In one example, the static width of the slot can be about 0.63 mm or less to minimize, such as prevent, undesirable release of cement material 30 from the interior area 50 under the force of gravity.

Unlike the application of the DC signal component, application of an AC signal component to the actuator produces an oscillating output of linear translation of rod 90. Oscillations of the rod 90 are transmitted through the rocker arm 96 to the moving member 66 and on to the oscillatory member 64. Oscillations in the oscillatory member 64 cause reciprocating movement of the dynamic lip 74 such that the width of the dispensing port 60 changes to define the dynamically changing width 104 of the dispensing port 60. Because the output of the rod 90 is proportional to the electrical signal input to the actuator 88, the frequency and the translation distance of the oscillatory member 64 oscillations can be accurately controlled. For example, increased frequency of the AC signal component input to the actuator 88 increases the frequency of the oscillatory member 64 oscillations. Similarly, increased amplitude of the AC signal component input to the actuator 88 increases the translation distance of the oscillatory member 64. Application of the AC signal component to the actuator 88 configures the dispensing port 60 to define the dynamically changing width 104 defined by a changing distance between the static lip and the dynamic lip when the slot is in the dynamic state.

Amplitudes of the oscillations of the oscillatory member 64 can be used to define a strain rate. In one example, the strain rate is defined as the dynamic travel distance of the reciprocating path of the dynamic lip 74 divided by the static width 78 of the dispensing port 60 expressed as a percentage. For instance, in one example, the static width 78 is about 1 mm and the dynamically changing width 104 changes from about 0.7 mm to 1.3 mm during oscillation. In such an example, the dynamic travel distance of the dynamic lip 74 is 0.6 mm (i.e., 1.3 mm−0.7 mm=0.6 mm) and the strain rate would be 0.6, or 60% (i.e., 0.6 mm/1 mm).

Control unit 84 can transmit a combination of a DC signal component and an AC signal component to the actuator 88 over along transmission line 86. The DC signal component moves the oscillatory member 64 to a baseline position to define the static width 78 and the AC signal component oscillates the oscillatory member 64 from the baseline position proportional to the frequency and amplitude of the AC signal component to define the dynamically changing width 104.

Oscillating action of the oscillatory member 64 modifies a material property of the cement material 30 being dispensed through the dispensing port 60. In one example, the oscillations of the oscillatory member 64 acting on the cement material 30 modify the viscosity of the cement material 30. Various mechanisms can effect this viscosity modification. In one example, the mechanism can be elongation forces acting on the cement material 30 to lower the viscosity. In another example, the mechanism can comprise shear forces acting on the cement material 30. In yet another example, a combination of elongation forces and shear forces can lower the viscosity of the cement material 30. For example, the viscosity of the cement material 30 can be lowered from about 50% to about 5%, such as from about 25% to about 5%, such as from about 10% to about 5%.

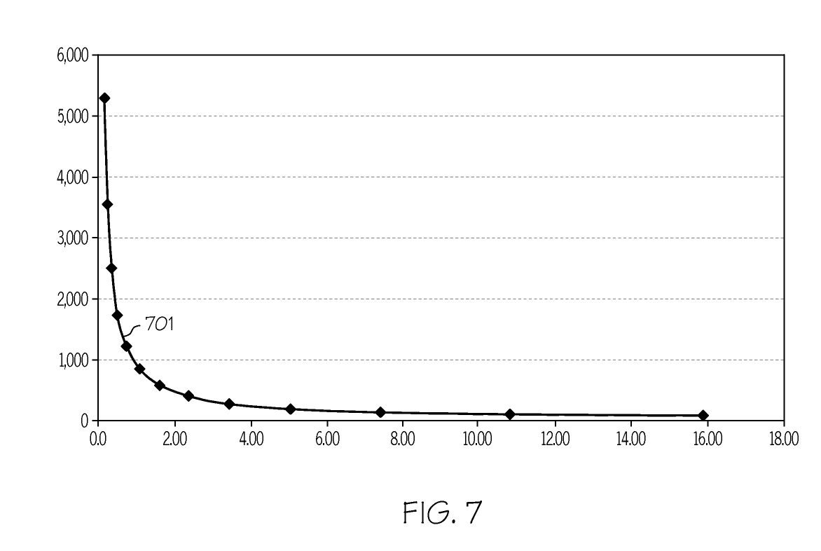

Turning to FIG. 7, plot 701 shows the visco-plastic behavior of an example cement material in response to various frequencies of the oscillatory member 64 physically acting on the cement material 30. The horizontal X-axis represents the shear rate applied to the cement material 30 by an example oscillatory member 64. The vertical Y-axis represents angular viscosity of the example cement material 30 as found by a two-plate rheology method measured in Pascals x seconds (Pa·s). As shown, increased shear rate decreases the viscosity of the example cement material 30.

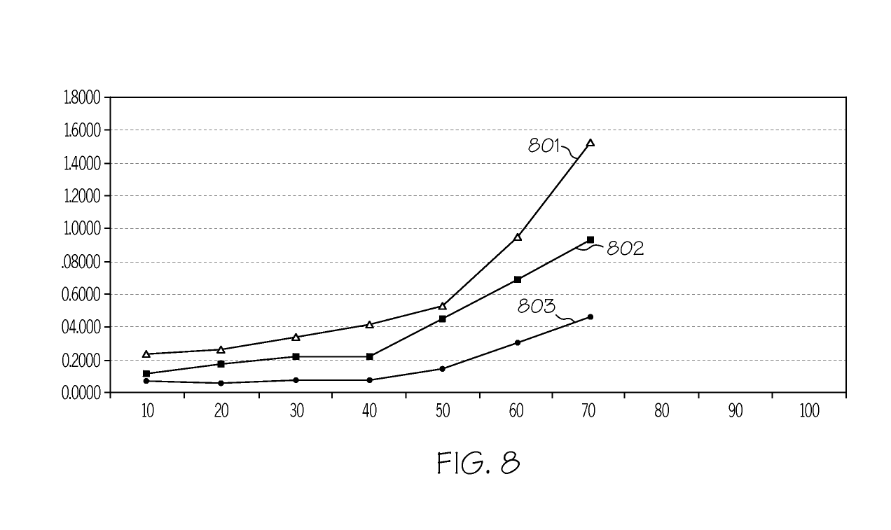

Turning to FIG. 8, plots 801, 802, 803 show flow rates of an example cement material 30 delivered by the flow applicator apparatus 40 operating at various frequencies. The plots 801, 802, 803 illustrate flow enhancement with increased frequency in oscillatory member 64 oscillations. Plot 801 represents a plot of flow of cement material through a flow applicator apparatus 40 with the oscillatory member 64 producing a strain rate of 90%. Plot 802 represents a plot of flow of cement material through a flow applicator apparatus 40 with the oscillatory member 64 producing a strain rate of 60%. Plot 803 represents a plot of flow of cement material through a flow applicator apparatus 40 with the oscillatory member 64 producing a strain rate of 30%. The horizontal X-axis represents frequency of the oscillatory member 64 oscillations in Hz. The vertical Y-axis represents the flow rate of the cement material 30 in pounds per 15 seconds. Plots can be produced to establish operating standards for various sizes of honeycomb bodies 20. For example, a preferred frequency and amplitude of the AC signal component may be selected to achieve desired flow characteristics of the cement material based on the dimensions of the particular honeycomb body 20. In one example, the oscillatory member 64 can reciprocate at a wide range of frequencies, such as from about 20 Hz to about 200 Hz, such as from about 40 Hz to about 70 Hz.

Methods of applying a layer of cement material 30 to the honeycomb body 20 can include the step of charging the interior area 50 with cement material 30. For example, as shown in FIG. 6, the cement material can be delivered to the interior area 50 through supply conduit 52. Supply conduit 52 can be connected to an inlet (not shown) defined by a portion of the applicator body 44 permitting fluid communication between the supply conduit 52 and the interior area 50. Variables regarding delivery of the cement material 30 such as fluid pressure, volumes, flow rate, and temperature can be predetermined according to the type and size of honeycomb body 20 to be coated, application speed, etc. In one example, the delivery pressure of the cement material 30 can be between about 0 to 138 kPa (0 to 20 psi) such as 17.2 kPa (2.5 psi).

The methods can also include the step of oscillating the oscillatory member 64 to modify a material property of the cement material 30. In one example, the viscosity of the cement material 30 is reduced by the force applied by the oscillatory member 64 onto the cement material 30 during oscillation. As seen in FIG. 7, in one particular example, the viscosity of the cement material 30 is modified to less than about 1,000 Pa·s. In a more particular example, the viscosity of the cement material 30 is modified to less than about 500 Pa·s. In a still more particular example, the viscosity of the cement material 30 is modified to less than about 250 Pa·s. In a further method, the viscosity of the cement material 30 is reduced by the dynamically changing width 104 between the static lip 72 and the dynamic lip 74 as the cement material 30 is passed through the dispensing port 60.

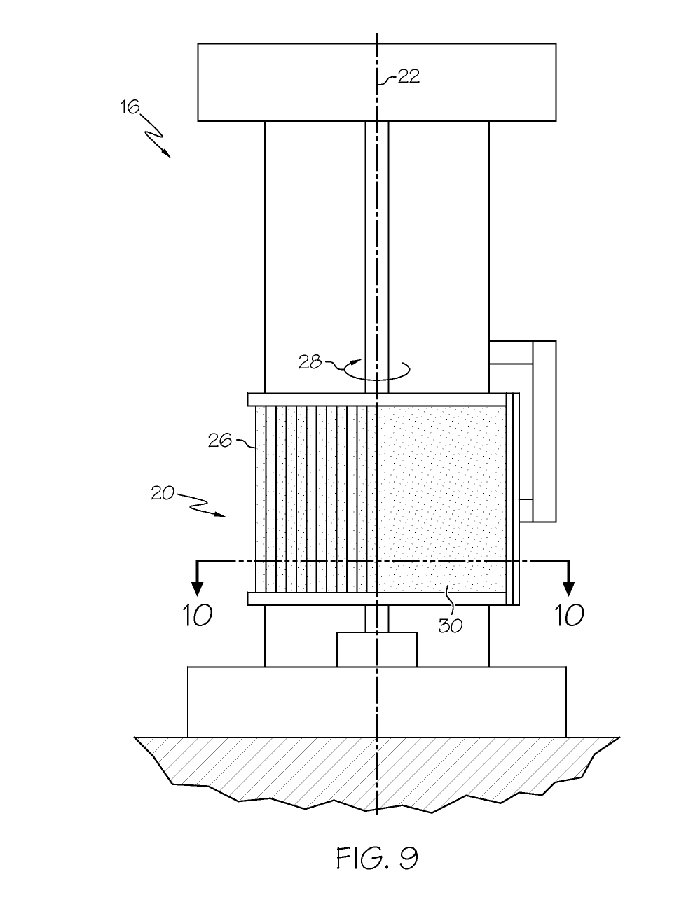

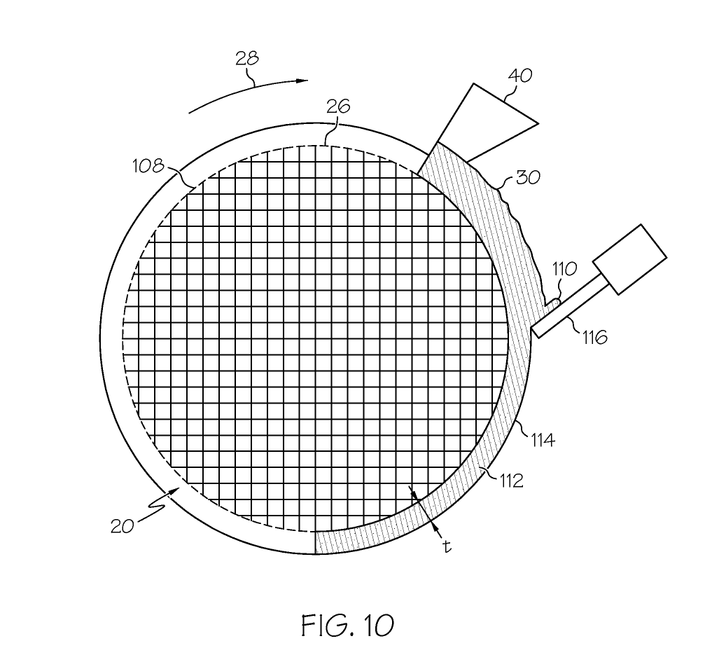

As shown in FIG. 9, the methods of the present invention also include applying the cement material 30 to the outer circumferential surface 26 of the honeycomb body 20. Application of the cement material 30 can include rotating the honeycomb body 20 and the flow applicator apparatus 40 relative to one another about the longitudinal axis 22. For example, the method can include the step of rotating the honeycomb body 20 relative to the flow applicator apparatus 40 about the longitudinal axis 22 in the direction of arrow 28. As shown in FIG. 10, rotation of the honeycomb body 20 relative to the flow applicator apparatus 40 can create a cement material layer 112, such as the illustrated skin 114 on the circumferential surface 26 of the honeycomb body 20 having a thickness corresponding to the depth “t.” A broken line 108 is shown in FIG. 10 indicating the outer dimension “d” of the circumferential surface 26. Extra portions 110 of the cement material 30 can gather to provide a consistent cement material layer 112 (i.e., skin) without discontinuities in the outer surface of the cement material layer 112.

Methods of the present invention can further include the step of contacting the cement material 30 with a blade 116 while rotating the honeycomb body 20 and the blade 116 relative to one another about the longitudinal axis 22. For example, the blade 116 may initially contact the cement material 30 with no relative rotation between the honeycomb body 20 and the blade 116 and then continue to contact the cement material 30 during relative rotation between the honeycomb body 20 and the blade 116 about the longitudinal axis 22. Contact between the blade 116 and the cement material 30 can result in the cement material layer 112 covering at least part, such as substantially the entire, circumferential surface 26 of the honeycomb body 20.

Further methods include oscillating the oscillatory member 64 within particular parameters. In one example, the control unit 84 can supply suitable signals to the actuator 88 to oscillate the oscillatory member 64 at a selectively controlled amplitude and/or strain rate. In one specific example, the selectively controlled amplitude is from about 30% to about 90% of a static width 78 of the dispensing port 60. In another example, the control unit 84 can supply suitable signals to the actuator 88 to oscillate the oscillatory member 64 at a selectively controlled frequency. As seen in FIG. 8, the flow rate of the cement material 30 can be dependent upon both the amplitude and the frequency of the oscillatory member 64.

The apparatus and methods described provide for improved application of cement materials to honeycomb bodies. Viscosity of the cement material can be lowered with the application of forces to the cement material with an oscillatory member. The cement material can then flow through the flow applicator apparatus in a more controlled manner. After the cement material is applied to the honeycomb body, the cement material viscosity will increase to return to its normal value, helping the cement material remain on the honeycomb body.

Additionally, the oscillatory member 64 can enhance the wet adhesion of the cement material to the honeycomb body to enhance the material utilization of the cement material. The wet adhesion between the cement material and the honeycomb body can be from a number of factors. In one example, the cement material exposed to oscillations of the oscillatory member exhibits an increased adhesive strength. In another example, the cement material exposed to oscillations of the oscillatory member exhibits a decreased cohesive strength. In yet another example, the cement material exposed to oscillations of the oscillatory member exhibits both an increased adhesive strength and a decreased cohesive strength.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A flow applicator apparatus comprising:
an applicator body including an interior area configured to receive a cement material, and a dispensing port configured to dispense cement material from the interior area; and
an oscillatory member configured to modify a material property of the cement material being dispensed through the dispensing port.

2. The flow applicator apparatus of claim 1, wherein the oscillatory member at least partially defines the dispensing port.

3. The flow applicator apparatus of claim 1, wherein the dispensing port comprises a slot including a static width defined by a distance between a pair of spaced apart lips.

4. The flow applicator apparatus of claim 3, wherein the static width of the slot is adjustable.

5. The flow applicator apparatus of claim 3, wherein the oscillatory member defines at least one of the lips as a dynamic lip.

6. The flow applicator apparatus of claim 1, wherein the dispensing port comprises a slot defined by a pair of spaced apart lips, wherein a fixed portion of the applicator body defines one of the pair of lips as a static lip and the oscillatory member defines the other of the pair of lips as a dynamic lip.

7. The flow applicator apparatus of claim 6, wherein the slot includes a static width defined by a distance between the static lip and the dynamic lip when the slot is in a static state, and wherein the slot is configured to define a dynamically changing width defined by a changing distance between the static lip and the dynamic lip when the slot is in a dynamic state.

8. The flow applicator apparatus of claim 7, wherein the static width of the slot is adjustable.

9. The flow applicator apparatus of claim 1, wherein the oscillatory member includes an elastically deformable material.

10. A method of applying a layer of cement material to a honeycomb body comprising a longitudinal axis extending through opposing end faces and an outer circumferential surface extending about the longitudinal axis and between the end faces, the method comprising the steps of:
(I) providing an applicator body including an interior area, a dispensing port and an oscillatory member;
(II) charging the interior area with cement material;
(III) oscillating the oscillatory member to modify a material property of the cement material;
(IV) dispensing the cement material from the interior area through the dispensing port; and
(V) applying the cement material to the outer circumferential surface of the honeycomb body.

11. The method of claim 10, wherein step (III) includes oscillating the oscillatory member to modify the material property comprising a viscosity of the cement material being dispensed during step (IV).

12. The method of claim 11, wherein the viscosity is modified to less than about 1,000 Pascal-seconds (Pa·s).

13. The method of claim 11, wherein the viscosity is modified to less than about 500 Pa·s.

14. The method of claim 13, wherein the viscosity is modified to less than about 250 Pa·s.

15. The method of claim 10, wherein step (III) includes oscillating the oscillatory member at a selectively controlled amplitude.

16. The method of claim 15, wherein the selectively controlled amplitude is from about 30% to about 90% of a static width of the dispensing port.

17. The method of claim 10, wherein step (III) includes oscillating the oscillatory member at a selectively controlled frequency.

18. The method of claim 17, wherein the selectively controlled frequency is from about 20 Hertz to about 200 Hertz.

19. The method of claim 18, wherein the selectively controlled frequency is from about 40 Hertz to about 70 Hertz.

20. A method of applying a layer of cement material to a honeycomb body comprising a longitudinal axis extending through opposing end faces and an outer circumferential surface extending about the longitudinal axis and between the end faces, the method comprising the steps of:
(I) providing an applicator body including an interior area, a dispensing slot including a static width defined by a distance between a first lip and a second lip, wherein the first lip is defined by an oscillatory member and the second lip is defined by a fixed portion of the applicator body;
(II) charging the interior area with cement material;
(III) oscillating the oscillatory member to provide a dynamically changing width between the first lip and the second lip;
(IV) dispensing the cement material from the interior area through the dispensing port, wherein a viscosity of the cement material is reduced by the dynamically changing width between the first lip and the second lip as the cement material is passed through the dispensing slot; and
(V) applying the dispensed cement material to the outer circumferential surface of the honeycomb body.
